(19) United States
(12) Patent Application Publication
(10) Pub. No.: US 2004/0267033 A1
(43) Pub. Date: Dec. 30, 2004

(54) Extraction of lutein from marigold meal

(76) Inventors: Jonnalagadda Raghunath Rao, Hyberabad, Andra Pradesh (IN); Gopu Bala Show Reddy, Hyberabad, Andra Pradesh (IN)

Correspondence Address: Richard C Litman, Litman Law Offices, P O Box 15035, Crystal City Station, Arlington, VA, 22215, US

(21) Appl. No.: 10/493,398

(22) PCT Filed: Nov. 2, 2001
(86) PCT No.: PCT/IB01/02057

(51) Int. Cl. C11B 1/00

(52) U.S. Cl. 554/8

(57) ABSTRACT

A chemical free two-stage process and the products for the extraction of lutein diester from marigold meal comprises dissolving lutein diester and lipophilic material from marigold meal in supercritical fluid carbon dioxide at certain temperatures and pressures, and separating out a high quality lutein diester extract(FIG. 2). The lutein diester extracted is utilized for human nutraceutical and food supplement applications.

### TECHNICAL FIELD

The present invention relates generally to isolation of a specific plant extract. More specifically, the invention is a process for recovering lutein from marigold petals for nutritional, coloring and medicinal purposes.

### BACKGROUND ART

The related art of interest describes various processes for obtaining lutein, but none discloses the present invention. There is a need for an effective process in obtaining maximum lutein without any solvent contamination from marigold petals which have been preformed in a meal state. The related art will be discussed in the order of perceived relevance to the present invention.

An article entitled “Super Critical Carbon Dioxide Extraction of Carotene and Lutein from Leaf Protein Concentrates” by Favio Favati et al., published in the Journal Of Food Science, Vol. 53, No. 5, pp. 1532-1536 in 1998, describes the supercritical carbon dioxide extraction of carotene and lutein for use as pigments from leaf protein concentrates serving as a substrate for the protein content. Supercritical carbon dioxide at a flow rate of 5-6 liters/minute using pressures of 10-70 MPa at 40° C. resulted in recovery of over 90% of the carotene. Removal of lutein required higher extraction pressures and gas volumes, with a 70% recovery at 70 MPa at 40° C. The extraction process is distinguishable for the leaf protein concentrate substrate, the single stage extraction procedure, and the presence of impurities or extraneous materials in the product.

U.S. Pat. No. 5,932,101 issued on Aug. 3, 1999, and U.S. Pat. No. 6,106,720 issued on Aug. 22, 2000, to Jeffrey S. Kanel et al. describe a process for fluid/dense gas extraction of carotenoid from brine containing an algae, carrot juice, and tomato skin under enhanced solubility conditions comprising flowing a supercritical fluid carbon dioxide presaturated with water in a column having a diameter greater than 3.5 cm. and a height to diameter ratio greater than 5 for processing at 450-1200 bar and 50-300° C. The extraction processes are distinguishable for recovering carotenoid only from various sources.

U.S. Pat. No. 4,632,837 issued on Dec. 30, 1986, to Erwin Schutz et al. describes a process for the production of concentrated extracts from fresh culinary herb plants such as dill, tarragon leaves, cassia buds, and mimosa flowers. The process comprises extraction by supercritical carbon dioxide at 0° to 40° C. and at a pressure of 80-200 bars, and separation of the extract by diethyl ether or pentane at a pressure of 20 to 60 bars and a temperature from 0° to 20° C. The process is distinguishable for its recovery of herb extracts with organic solvent separation.

U.S. Pat. No. 5,382,714 issued on Jan. 17, 1995, to Frederick Khachik describes a lutein product and a process for isolation, purification, and recrystallization of lutein from saponified marigold oleoresin comprising the mixing of a saponified marigold extract with an alcohol/water mixture, lowering the temperature to precipitate lutein crystals, washing the crystals with water and with an organic solvent mixture, and recrystallizing the lutein. The process is distinguishable for utilizing organic solvents.

U.S. Pat. No. 4,048,203 issued on Sep. 13, 1977, to Thomas Philip describes a purification of lutein-fatty acid esters from marigold flower petals or marigold petal oleoresins based on alkanol precipitation. The purified colorant is suitable for coloring foods in the yellow to red region. The process is distinguishable for utilizing alkanols.

U.S. Pat. No. 4,466,923 issued on Aug. 21, 1984, to John P. Friedrich describes a supercritical carbon dioxide extraction of lipids from lipid-containing materials such as vegetable seed, cereal seed germ and animal meat by the simultaneous application of temperatures 60°-80° C. and pressures of 700-1200 bar. The process is distinguishable for the recovery of lipids.

U.S. Pat. No. 4,493,854 issued on Jan. 15, 1985, to John P. Friedrich et al. describes the production of defatted soybean products by supercritical fluid extraction comprising treatment of soybean material by supercritical fluid carbon dioxide under a temperature range of 81° C. to 100° C. under a pressure of 793-855 bar. The process is distinguishable for extracting fat from soybeans.

U.S. Pat. No. 4,511,508 issued on Apr. 16, 1985, to Heinz-Rudiger Vollbrecht et al. describes a process for drying natural extracts of hop pellets, fresh hops, and camomile blossoms prepared by high pressure extraction by supercritical fluid carbon dioxide and removing moisture by utilizing-a drying agent such as magnesia, alumina or calcium sulfate. The process is distinguishable for the drying of different materials with desiccating agents.

U.S. Pat. No. 5,120,558 issued on Jun. 9, 1992, to Uy Nguyen et al. describes a process for the supercritical continuous four-vessel extraction of ground (30 mesh) spices such as sage, vanilla, pepper, celery, ginger, cinnamon by carbon dioxide at 400-600 bar and 80°-120° C., and fractionation of spices to obtain oleoresin. The process is distinguishable for recovering oleoresins from spices.

U.S. Pat. No. 5,252,729 issued on Oct. 12, 1993, to Michelle A. De Costa et al. describes an extraction of compounds such as sterols, diosgenin and sarsapogenin from acid hydrolyzed barbasco root and Yucca seed using supercritical fluid carbon dioxide and an optional solvent such as carbon tetrachloride or isopropyl alcohol. The process is distinguishable for utilizing solvents and acids.

U.S. Pat. No. 5,591,343 issued on Jan. 7, 1997, to Motomitsu Kitaoka et al. describes a process for extraction of carotenoids excluding lutein from bacterial cells comprising extraction by supercritical carbon dioxide at 31°-100° C. and pressures of 75.2 kgf/cm²-500 kgf/cm² with entrainer fluids such as methanol and isopropanol. The process is distinguishable for extraction in the presence of organic solvents.

U.S. Pat. No. 5,789,647 issued on Aug. 4, 1998, to Jurgen Heidlas et al. describes a process for the extraction of natural carotenoid dyes as oils by utilizing compressed propane and/or butane and entraining agents such as acetone, ethanol and ethyl acetate at 20°-90° C. and pressures of 10-200 bar to extract from pre-dried animal, plant or microbial material and crystallized. The process is distinguishable by relying on organic materials.

U.S. Pat. No. 5,830,738 issued on Nov. 3, 1998, to Ronald L. Thomas et al. describes a process for extracting carotenoids from shredded plant material by adding enzymes such as pectinase, cellulase, hemicellulase or mixtures thereof and washing with an alcohol. The process is distinguishable for requiring enzymes and an alcohol wash.

U.S. Pat. No. 5,959,138 issued on Sep. 28, 1999, to Mario-David Torres-Cardona et al. describes a process to obtain short chain diesters including lutein by reacting saponified marigold meal extracts with acetic or propionic anhydride at 25° to 140° C. to form an oily phase in an inert atmosphere. Ethylene glycol or propylene glycol is added to reduce the viscosity of the mixture. The saponification reaction is performed with sodium or potassium hydroxide. The process is distinguishable for its use of organic materials and the generic quality of the short chain diesters obtained.

U.K. Patent Application No. 2 119 399, published on Nov. 16, 1983, for Brian R. Evans et al. describes an extraction of milled hop pellets by carbon dioxide under pressure to extract oil and resin components. The process is stopped to displace the carbon dioxide and the extracts to another location. If liquid carbon dioxide is used, it is displaced to an evaporator containing the extract under isobaric pressure, and the carbon dioxide being gasified. If supercritical carbon dioxide is used, the pressure in the pressure vessel is higher than when it is displaced to a separator. The plant material may be steeped in liquid carbon dioxide and displaced as aforementioned. The gases are vented to the atmosphere or recovered. The process is distinguishable for its recovery of oil and resin components of milled hop products.

Japan Patent Application No. 1-127002, published on May 19, 1989, for Setsuo Inouye describes a biomass aqueous solution being processed to remove the biomass by a supercritical fluid composition of carbon dioxide and ethylene. The process is distinguishable for requiring ethylene.

E.P.O. Patent Application No. 0 521 675 A1 published on Jan. 7, 1993, for Jayaprakash B. Nair describes a method for extracting taxanes such as taxol by using supercritical carbon dioxide and an organic solvent for taxane. The method is distinguishable for requiring an organic solvent.

E.P.O. Patent Application No. 0 672 655 A1 published on Sep. 20, 1995, for Frederick Khachik describes a process of isolation, purification, and recrystallization of lutein from saponified marigold oleoresin through the use of a series of filtrations and water/alcohol washes to obtain crude lutein crystals. The crystals are dissolved in a halogenated organic solvent and then partially dissolved in a second solvent. Upon cooling, lutein is recrystallized in a high purity, filtered and dried under a vacuum. The process is distinguishable for processing saponified marigold oleoresin and not requiring supercritical carbon dioxide treatment of lutein.

P.C.T. Patent Application No. WO 99/20587 published on Apr. 29, 1999, for Frederick Khachik describes a process for extraction and purification of lutein, zeaxanthin and rare carotenoids from marigold flowers and plants without the use of harmful organic solvents to serve as a safe source of nutritional supplement for human consumption and providing a color additive for foods. The method employs a combination of tetrahydrofuran, alcoholic potassium or sodium hydroxide at room temperature under mild conditions to effect the hydrolysis of lutein and zeaxanthin fatty acid esters in marigold flowers and Lycium Chinese Mill berries. The process is distinguishable for the use of different chemicals at room temperature.

U.K. Patent Application No. GB 2311 009 A published on Sep. 17, 1997, for Mohd T. Kahn describes pharmaceutical base preparations comprising extracts of various whole plant marigolds. The compositions are distinguishable as being limited to pharmaceutical preparations.

P.C.T. Patent Application No. WO 99/54408 published on Oct. 28, 1999, for Luis Levy describes the processing of only the corollas or petals of marigold flowers to extract lutein concentrates to eliminate pesticide residues in parts per billion. The method of obtaining a trans-xanthophyll ester concentrate comprises contacting the marigold petals with a hydrocarbon solvent (pentane, hexane, heptane, and mixtures thereof) to extract xanthophyll esters, separating the liquids out, evaporating the hydrocarbon solvent to obtain a crude concentrate, dissolving the concentrate in an alcohol, and removing the alcohol to obtain a purified trans-xanthophyll ester concentrate. The process is distinguishable for performing the operations at room temperature.

None of the above inventions and patents, taken either singly or in combination, is seen to describe the instant invention as claimed. Thus, an extraction of lutein from marigold meal solving the aforementioned problems of solvent contamination is desired.

### DISCLOSURE OF THE INVENTION

The present invention is directed to a process for the extraction of lutein diester from marigold meal, and the product obtained by the process. The process includes a step of milling dry marigold flower petal meal to small size particles. A first extractor apparatus is provided. The milled marigold meal is passed to a first extractor apparatus. The marigold meal particles are fluidized in a mass carbon dioxide flow ranging from 20-80 kgm/kgm of dry marigold meal to form a process stream. The milled meal is dissolved in supercritical fluid carbon dioxide in the first extractor apparatus, so that lutein diester and lipophilic materials of the milled marigold meal are dissolved in the supercritical fluid carbon dioxide. Another step is providing at least one separator apparatus. The dissolved materials are separated from the supercritical fluid carbon dioxide in the separator apparatus, whereby 10 to 15% lutein diester and lipophilic materials are obtained.

Also part of the invention is a process for purifying and enhancing lutein diester content of a lutein diester extract derived from marigold meal, and the product obtained by the process. The process includes a step of fractionating a lutein diester extract having a lutein diester content of between about 10 to 15% in an extractor apparatus at a pressure range of 200 to 350 bar of supercritical fluid carbon dioxide flow at a temperature range of 40-80° C. The fractionated dissolved material is separated from gaseous material in a first separator apparatus maintained at 60 to 140 bar pressure and a temperature range of 40°-80° C. The fractionated material is further separated from gaseous material in a second separator apparatus maintained at 40-50 bar pressure and 15°-25° C., whereby the extract is deodorized, volatile material and saturated fats are removed, and the concentration of lutein diester in the extract is increased.

Also part of the invention is a two-stage process for the extraction of lutein diester from marigold flower petal meal. The two stages correspond to the two processes described above.

### BRIEF DESCRIPTION OF THE DRAWINGS

FIG. 1 shows the structure of various lutein isomers.

FIG. 2 is a schematic diagram of an apparatus for extraction of lutein from marigold meal according to the present invention.

FIG. 3 is a bar graph showing the recovery pattern by this process.

FIG. 4A is a table showing the extraction parameters and recovery patterns.

FIG. 4B is a continuation of the table of FIG. 4A.

FIG. 5A is a table showing the lutein diester fractionation parameters.

FIG. 5B is a continuation of the table of FIG. 5A.

### BEST MODES FOR CARRYING OUT THE INVENTION

The present invention is directed to a process and the product produced by the process, wherein dry marigold flower in the form of a dry meal is processed at specific pressures and temperatures using supercritical fluid carbon dioxide to produce a lutein diester extract useful for nutrition and food coloring.

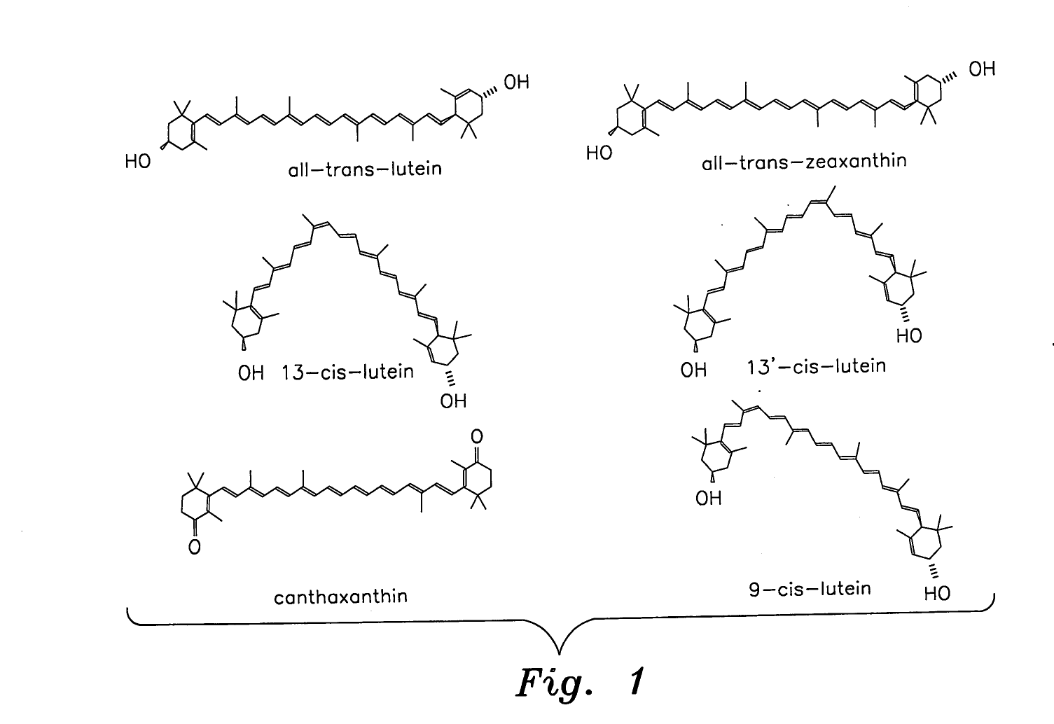

However, it would be best to provide the following background information regarding the value of the plant extract. Carotenoids are widely distributed among plants, and are, after chlorophyll, the most abundant kind of non-toxic pigments for human consumption. These compounds have received special attention because of their vitamin-A and antioxidant activities which help in the prevention and treatment of cancer, cardiovascular, neurodegenerative, and eye diseases such as age-related macular degeneration, glaucoma and cataracts. In plants, the hydroxylated carotenoids, i.e., xanthophylls, occur acylated with fatty acids and their esters are highly soluble in oil as contrasted with their parent xanthophylls. Thus, xanthophyll fatty acid esters could be used for coloring fat-based foods and water-based foods. Currently, lutein has received interest as a natural, fat soluble carotenoid that has no vitamin-A activity. Several structural isomers of lutein were reported as presented in FIG. 1 as all-trans-lutein, all-trans-zeaxanthin, 13-cis-lutein, 13′-cis-lutein, canthaxanthin, and 9-cis-lutein. All-trans-lutein (all-E-lutein) having the stereo configuration of 3R, 3′R and 6′R corresponding to the human serum/plasma lutein has been shown to be the most effective antioxidant molecule compared to cis-lutein isomers (Z-isomers). It should be noted that lutein in this invention always refers to all-trans (all-E) lutein only.

Marigold flower petals, Tagetes erecta, contain one of the highest known concentrations of lutein in nature. Marigold can be cultivated easily, and is commercially grown in Central America and India as a pigment source for poultry in the form of dried flowers. Lutein accounts for over 60% of the total xanthophylls in marigold flowers, and occurs acylated as mono- or diesters linked with long chain fatty acids such as lauric, palmitic and myristic acids. Lutein is the major colorant present in egg yolk consumed by humans. The high concentration of lutein in marigold flower petals, the high solubility of lutein-fatty acid esters in vegetable oil, and the known non-toxicity of lutein make it an attractive colorant for human food. The marigold extracts produced according to the present invention contain lutein esters which account for 93% of the total lutein, zeaxanthin and their isomers.

The present invention relates to a completely chemical free process for the production of a lutein extract in varying lutein content, i.e., 10%, 15%, 20%, and 25%, using dry marigold flower meal. The process is carried out in two steps of dissolving and simultaneous separation and fractionation contrasted with the conventional multi-step extraction and purification. The process produces a stable product because the entire process is performed with inert supercritical fluid carbon dioxide at relatively lower temperatures, high pressures and short extraction time cycles. The process completely eliminates undesirable odors, volatile substances, and lower fatty oils along with most of the saturated fatty oils resulting in a high quality lutein product for direct application in the nutraceutical and human dietary supplement arts.

The process for the production of lutein diester of 20-25% from dry marigold flower meal was carried out in two processing stages at a product development unit and a commercial plant.

The product development unit had the following equipment and processing parameters: One extractor with 5 liter capacity; 2 separators; a high-pressure carbon dioxide pump, 1000 bar capacity; and a carbon dioxide recycle system with heating and chilling units.

The commercial plant had the following equipment: 2 extractors with volumes of 600 liters and 800 liters; 2 separators; a high pressure carbon dioxide pump with a maximum pressure of 500 bar; and a carbon dioxide recycle system with heating and chilling units.

STAGE 1:

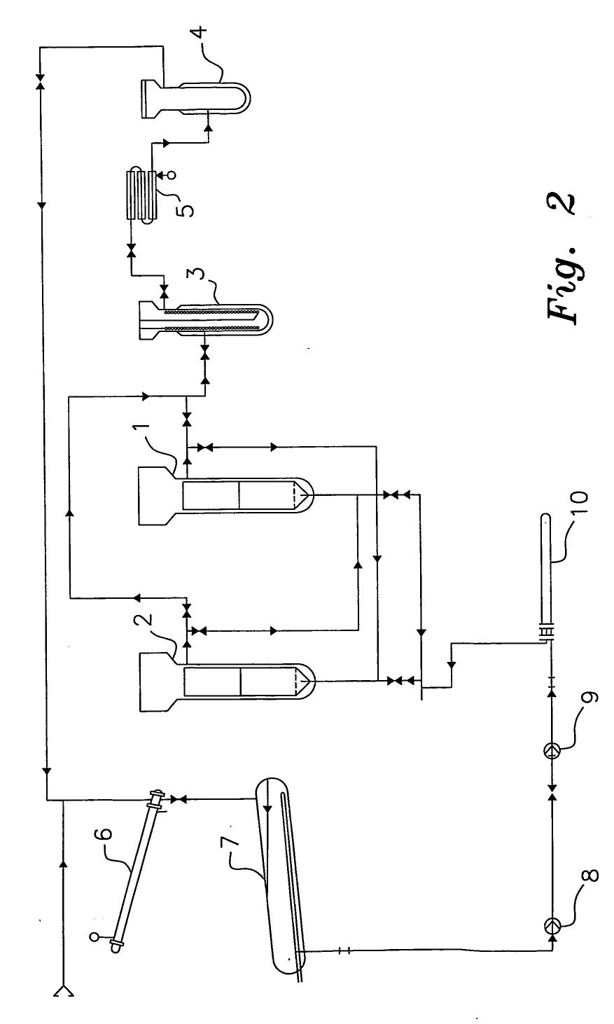

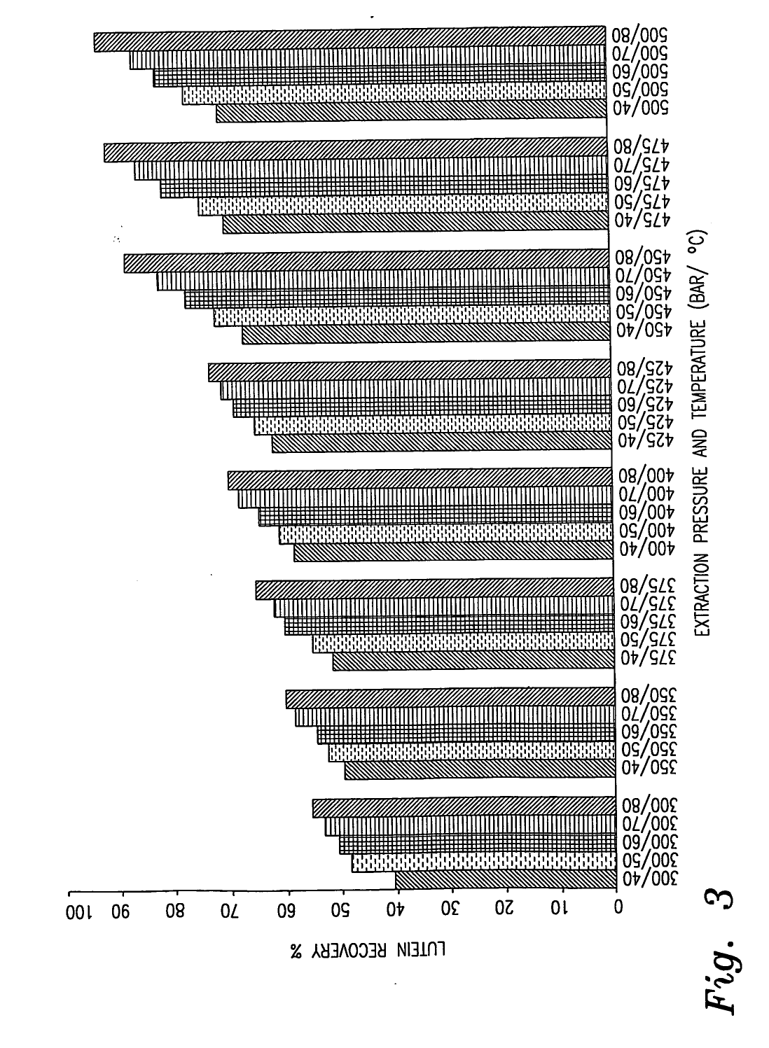

The dry marigold flower meal procured from farmers has a lutein diester content range of 0.7% to 1.3% averaging in a lutein content of 1.0%. FIG. 2 shows a supercritical fluid carbon dioxide (SCF-CO₂) extraction process flow diagram-commercial extraction apparatus. FIG. 3 shows the recovery pattern of lutein diester by SCF-CO₂ process at different pressures and temperatures from dry marigold flower meal. In the process system depicted in FIG. 2, better solubility and a total recovery of 85%-90% lutein diester was determined to occur at 475 bar pressure and 70° C. as shown in FIG. 3.

Dry marigold flower meal was milled to a mesh size of 600-800 microns, loaded into a removable basket and inserted in the extractor apparatus 2 and/or 1. Liquid carbon dioxide at 45 bar from the main tank (not shown) is fed to the condenser 6 to eliminate any moisture and fed to the carbon dioxide day tank 7. A booster pump 8 forces the carbon dioxide to the main pump 9, wherein a higher pressure is produced for passage to the liquid carbon dioxide preheater apparatus 10. The preheated and pressurized carbon dioxide is converted into supercritical fluid carbon dioxide and passed to extractor apparatus 2 and/or 1 by appropriate valves. The high pressure carbon dioxide fluidizes the flower meal for efficient dissolution of the lutein content in the supercritical fluid carbon dioxide. The extractor apparatus 2 was maintained at various pressures between 300 and 500 bar and temperatures between 40° and 80° C., as shown in FIG. 3, with a mass carbon dioxide flow ranging from 20-80 kgm./kgm. dry marigold meal. The process stream can be passed from extractor apparatus 1 and recycled to extractor apparatus 2 and vice-versa. When the process stream has been determined to have the maximum concentration of the lutein, the stream is passed to the first separator apparatus 3, the vaporizer apparatus 5 and a second separator apparatus 4 for final storage. The process stream from the extractor apparatus 1 and/or 2 enters the separator apparatus 3, which is maintained at various pressures between 300-500 bar and temperatures between 40°-80° C. with a mass flow of carbon dioxide of 20-80 kgm/kgm dry marigold meal. The separator apparatus 3 is a centrifugal separator.

The supercritical fluid carbon dioxide from the extractors 1 or 2 is saturated with dissolved active ingredients and enters the separator 3, which is maintained at pressures between 60 and 140 bar and a temperature range of 40-80° C. Under these conditions the lutein diester along with lipophilic materials was separated and collected. The supercritical fluid carbon dioxide from the separator 3 was vaporized to the carbon dioxide gas, to the carbon dioxide recycle system pressure and passed to the separator 4 which was maintained at 40-50 bar pressures at 15-25° C. temperatures. The dissolved undesirable odors, volatile matter and lower fatty oils in the carbon dioxide gas stream were separated and collected in separator 4. The carbon dioxide gas at 45 bar from separator 4 was condensed in the condenser 6 and collected in the day tank 7 and recycled. The entire process of extraction was completed in 2 hours and 30 minutes. The lutein extracts from the separators 3 and 4 were collected under pressure.

The lutein diester extract collected from separator 3 was analyzed spectrophotometrically to give a result of 10-15% lutein diester content with the yield of 7.0 to 8.0% from the dry marigold flower meal, with lutein content of 1.0 to 1.2%.

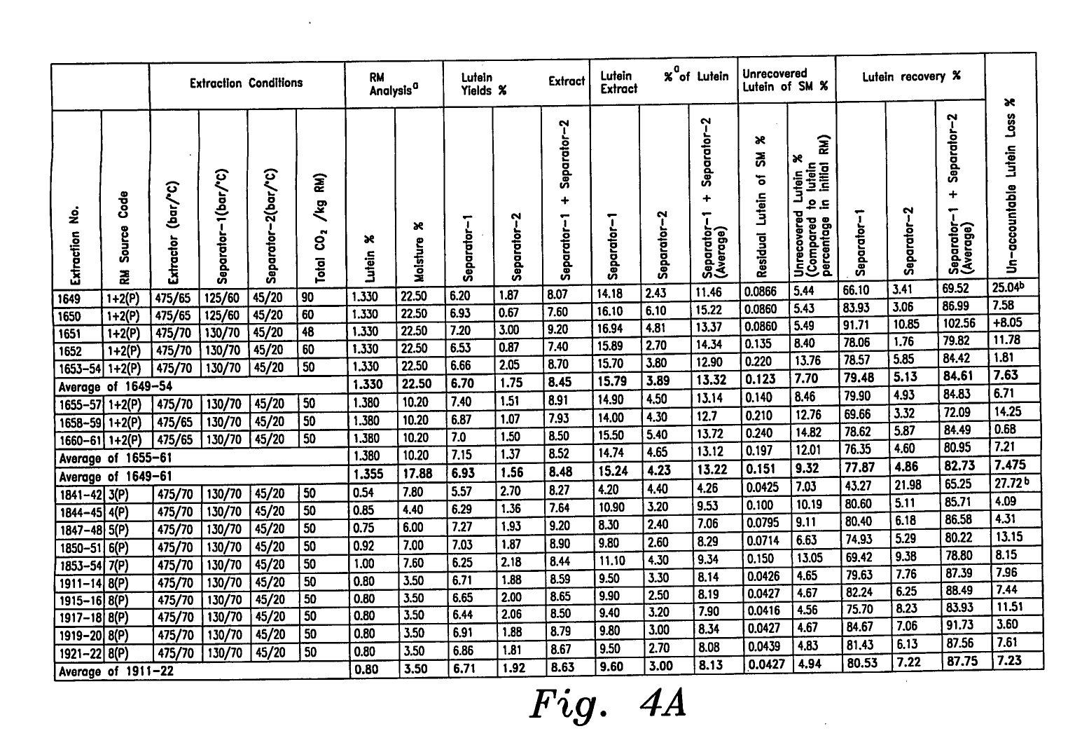

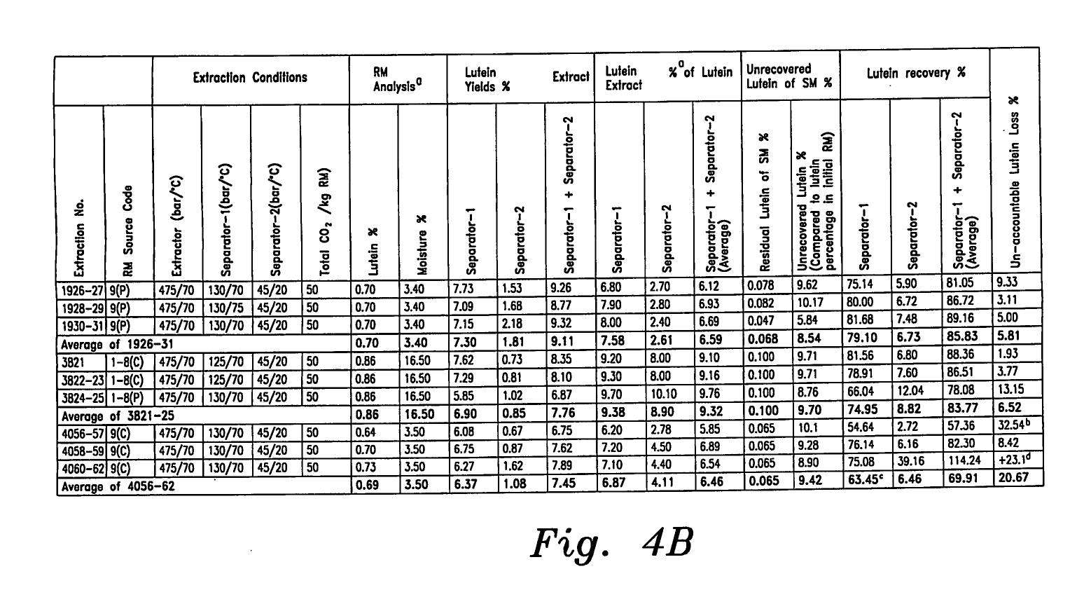

FIG. 4A shows the extraction parameters and recovery pattern of lutein diester by SCF-CO₂ process from dry marigold flower meal. FIG. 4B is a continuation of the table of FIG. 4A. In FIGS. 4A and 4B, the abbreviations used are as follows:

^{a}=analyzed spectrophotometrically (AOAC 1985/1995)

P=Product Development Unit

C=Commercial Plant

1+2=Novo+MKR gardens

3=Naturite

4=Novo gardens

5=MKR gardens

6=MKR gardens

7=Novo gardens

8=Rishi Herbals

9=Local farms (summer crop)

^{b}=material sticks in the initial batches

^{c}=poor recovery due to low Lutein content in the dry marigold flower meal

^{d}=incomplete collection of extract in the early batches

RM=Raw Material (dry marigold flower meal

SM=Spent Meal after extraction.

STAGE 2:

The enrichment of lutein diester content of 10-15% in the extract to 20-25% by fractionation by supercritical carbon dioxide process in the commercial plant was performed as follows.

The 10-15% lutein diester extract product from STAGE 1 was loaded into the extractor and fractionated between 200 and 350 bar pressures at a temperature range of 40-80° C. by passing 100-300 kgm. of supercritical carbon dioxide per kgm. of lutein diester extract loaded so that the extract was deodorized and volatile matter and saturated fats were effectively removed. Pressures of separators 3 and 4 were maintained under the same conditions as in STAGE 1. The enriched extract from the extractors were collected under carbon dioxide pressure, analyzed and found to contain lutein diester content of 20-25% with a yield of 3.5-4.0%/kgm. of dry marigold flower meal.

Ultraviolet/visible spectrophotometric analysis was performed on the product dissolved in hexane by taking the absorption of the sample at 447 nm. at an extinction coefficient of E 1% of 1 cm. of standard lutein 2670. The lutein diester content was also analyzed by high pressure liquid chromatography. The entire process was completed in 150 minutes.

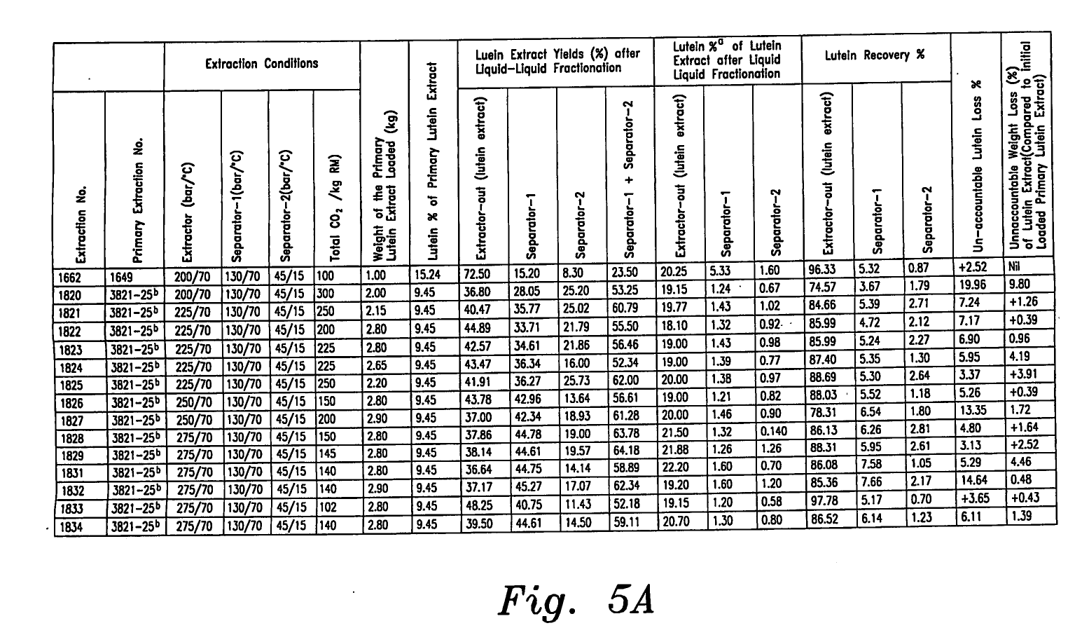

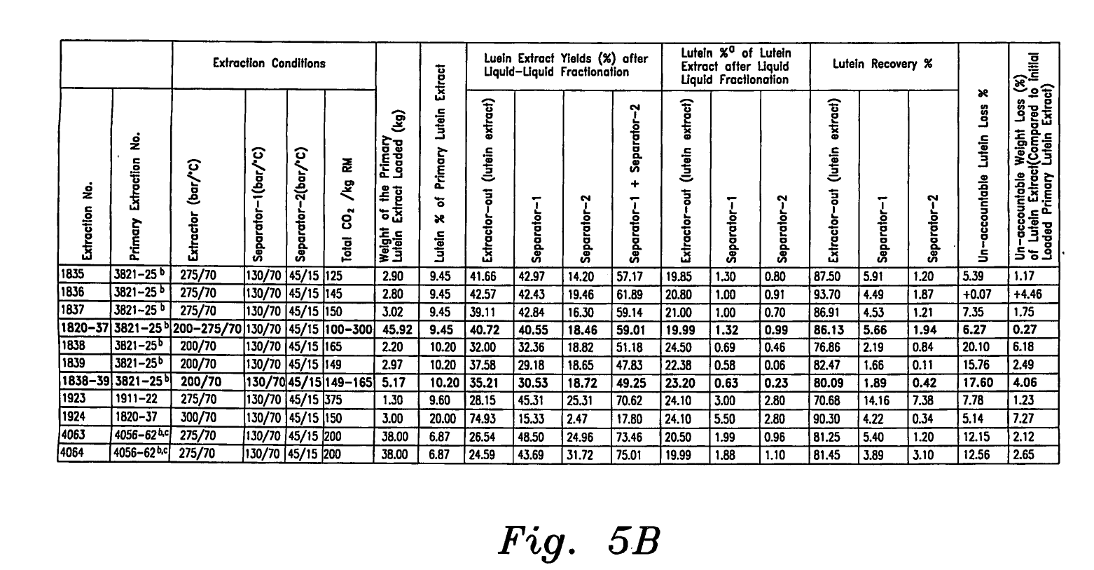

FIG. 5A shows the parameters for liquid-liquid fractionation of lutein diester extract of 10-15% lutein content by SCF-CO₂ process. FIG. 5B is a continuation of the table of FIG. 5A. In FIGS. 5A and 5B, the abbreviations used are as follows:

^{a}=analyzed spectrophotometrically (AOAC 1984/1995)

^{b}=primary lutein extract obtained from dry marigold meal in the Commercial Plant

^{c}=liquid-liquid fractionation was carried out in the Commercial Plant.

Thus, an effective method of obtaining high quality lutein diester by repeating the purification has been shown without the use of noxious prior art solvents to obtain 10-15% and 20-25%, respectively.

It is to be understood that the present invention is not limited to the embodiment described above, but encompasses any and all embodiments within the scope of the following claims.

We claim:

1. A process for the extraction of lutein diester from marigold meal comprising the steps of:
milling dry marigold flower petal meal to small size particles;
providing a first extractor apparatus;
passing the milled marigold meal to a first extractor apparatus;
fluidizing the marigold meal particles in a mass carbon dioxide flow ranging from 20-80 kgm/kgm of dry marigold meal to form a process stream;
dissolving the milled marigold meal in supercritical fluid carbon dioxide in the first extractor apparatus, whereby lutein diester and lipophilic materials of the milled marigold meal are dissolved in the supercritical fluid carbon dioxide;
providing at least one separator apparatus; and
separating the dissolved materials from the supercritical fluid carbon dioxide in the at least one separator apparatus, whereby 10 to 15% of the lutein diester and lipophilic materials are obtained.

2. The process for the extraction of 10-15% lutein diester from marigold meal according to claim 1, wherein the step of milling the dry marigold flower petal meal comprises milling the meal to a particle size range of about 600 to 800 microns.

3. The process for the extraction of 10-15% lutein diester from marigold meal according to claim 1, further comprising the steps of:
providing a second extractor apparatus; and
recycling the process stream from the first extractor apparatus to the second extractor apparatus for maximum extraction of lutein diester by supercritical fluid carbon dioxide.

4. The process for the extraction of 10-15% lutein diester from marigold meal according to claim 1, further comprising the step of maintaining the extractor apparatus in a temperature range of 40° to 80° C. and a pressure range of 300 to 500 bar.

5. The process for the extraction of 10-15% lutein diester from marigold meal according to claim 1, wherein the separator apparatus is a centrifugal apparatus.

6. The process for the extraction of 10-15% lutein diester from marigold meal according to claim 1, further comprising the step of maintaining the separator apparatus in a temperature range of 40° to 80° C. and a pressure range of 60 to 140 bar.

7. The product produced by the process for the extraction of lutein diester from marigold meal according to claim 1.

8. A process for purifying and enhancing lutein diester content of a lutein diester extract derived from marigold meal, comprising the steps of:
fractionating a lutein diester extract having a lutein diester content of between about 10 to 150% in an extractor apparatus at a pressure range of 200 to 350 bar of supercritical fluid carbon dioxide flow at a temperature range of 40-80° C.;
separating the fractionated dissolved material from gaseous material in a first separator apparatus maintained at 60 to 140 bar pressure and a temperature range of 40°-80° C.; and
further separating the fractionated material from gaseous material in a second separator apparatus maintained at 40-50 bar pressure and 15°-25° C.;
whereby the extract is deodorized, volatile material and saturated fats are removed, and the concentration of lutein diester in the extract is increased.

9. The process for purifying and enhancing lutein diester content according to claim 8, wherein the step of fractionating the lutein diester extract further comprises passing supercritical carbon dioxide into the extractor apparatus at a rate between about 100 and 300 kilograms per kilogram of lutein diester extract loaded into the extractor apparatus.

10. The product produced by the process for purifying and enhancing lutein diester content according to claim 8.

11. A two-stage process for the extraction of lutein diester from marigold flower petal meal in two stages comprising:
milling dry marigold flower petal meal to small size particles;
passing the marigold meal into an extractor apparatus;
dissolving the milled meal in supercritical fluid carbon dioxide in at least one extractor apparatus while fluidizing the marigold meal particles in a mass carbon dioxide flow ranging from 20-80 kgm./kgm. of dry marigold meal to form a process stream; and
separating the dissolved materials from the supercritical fluid carbon dioxide in at least one separator apparatus to obtain 10 to 15% lutein diester extract and lipophilic materials;
fractionating the lutein diester extract in the extractor apparatus at a pressure range of 200 to 350 bar of supercritical fluid carbon dioxide flow at a temperature range of 40-80° C.;
separating the fractionated dissolved material from gaseous material in a first separator apparatus maintained at 60 to 140 bar pressure and a temperature range of 40°-80° C.; and
further separating any fractionated material from gaseous material in a second separator apparatus maintained at 40-50 bar pressure and 15°-25° C. to remove volatile matter, saturated fat and noxious odors;
whereby a concentrated and purified lutein diester product is obtained.

12. The two-stage process according to claim 11, wherein the concentrated and purified lutein diester product has a concentration of 20 to 25% lutein diester.
